(19) United States
(12) Patent Application Publication
(10) Pub. No.: US 2006/0272510 A1
(43) Pub. Date: Dec. 7, 2006

(54) Coffee cup

(76) Inventor: Horng-Jhy Tsay, Keelung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,033

(22) Filed: Jun. 6, 2005

(51) Int. Cl. A47J 31/44

(52) U.S. Cl. 99/279

(57) ABSTRACT

A coffee cup for instantly brewing ground coffee is provided. The coffee cup combines the design of a paper cup to include a disposable filter cover inset with a filter bag, and a ground coffee sachet, sugar sachet and cream sachet are disposed in the cup body. When using the coffee cup, the ground coffee powder is disposed in the filter cover, and brewed by hot water. The brewed coffee would then drip into the cup body, and cream and sugar can be added according to taste. Accordingly, the present invention is able to provide convenient, fast, authentic, cheap and freshly brewed coffee.

### BACKGROUND OF THE INVENTION

1. Field of the Invention

The present invention relates to a coffee cup incorporating the design of paper cup and built-in coffee filter, to provide a convenient, fast, cheap, authentic and freshly brewed coffee.

2. Description of the Related Art

Nowadays, the coffee drinkers are growing in numbers. However, for coffee drinkers to get authentic and freshly brewed coffee, they need to either frequent the coffee shops, or purchase expensive equipment, which is time-consuming and toilsome for them. Otherwise, they have to compromise with the 3-in-1 coffee or instant coffee which has lost its authentic flavor. In either case, a convenient, fast, cheap and authentic coffee is still not available in the market for the coffee lovers.

### SUMMARY OF THE INVENTION

Accordingly, at least one objective of the present invention is to provide a coffee cup for instantly brewing ground coffee, suitable for providing the consumers with convenient, fast, cheap and authentic coffee.

To achieve this and other advantages and in accordance with the purpose of the invention, as embodied and broadly described herein, the invention provides a coffee cup for instantly brewing ground coffee. Wherein, the coffee cup comprises mainly of a cup body, a filter cover, a filter bag and a ground coffee sachet. Wherein, the filter lid is adapted to cover the cup body, the filter bag is disposed on the filter cover, and the ground coffee sachet is disposed in the cup body. The ground coffee powder in the ground coffee sachet is adapted to be disposed inside the filter bag. When hot water is poured into the filter cover and passes through the ground coffee powder and the filter bag, the infiltrated coffee liquid would flow into the cup body, and the coffee dreg would stay in the filter bag, to be discarded along with the filter cover and the filter bag.

According to the coffee cup for instantly brewing ground coffee in an embodiment of the present invention, the cup body further comprises a handle, for example, and the handle can be a folded handle.

According to the coffee cup for instantly brewing ground coffee in an embodiment of the present invention, the filter cover further comprises at least one inspection hole, for example, adapted for the user to observe whether the water amount exceeds the top edge of the cup body when pouring hot water.

The coffee cup for instantly brewing ground coffee in an embodiment of the present invention further comprises a sugar sachet, a cream sachet and/or a stir spoon disposed inside the cup body, for example.

According to the coffee cup for instantly brewing ground coffee in an embodiment of the present invention, the filter bag is a paper filter bag or a cloth filter bag, for example.

The present invention applies the brewing principle of a coffee filter to add a filter (inset filter) on a paper cup. When brewing the coffee, the coffee powder is taken out and poured into the cup, and brewed by hot water until 80% full (about 150 c.c.), then the cup cover is discarded. Then, sugar and cream is added according to taste to the coffee, thus an authentic, pure and rich cup of coffee is made.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and is incorporated in and constitute a part of this specification. The drawing illustrates embodiments of the invention and, together with the description, serves to explain the principles of the invention.

FIG. 1 is a schematic drawing of a coffee cup for instantly brewing ground coffee according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

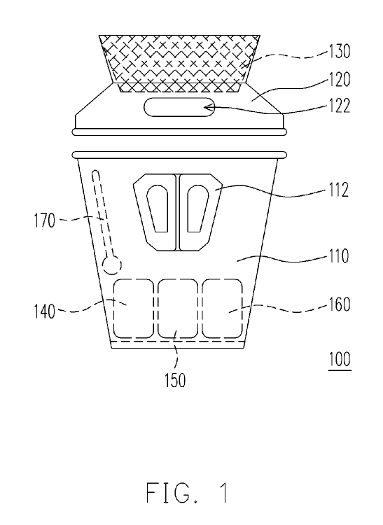

FIG. 1 is a schematic drawing of a coffee cup for instantly brewing ground coffee according to an embodiment of the present invention. Referring to FIG. 1, the coffee cup for instantly brewing ground coffee mainly comprises a cup body 110, a filter cover 120, a filter bag 130 and a ground coffee sachet 140. Wherein, the filter cover 120 is adapted to cover the cup body 110. The filter bag 130 is disposed on the filter cover 120. The ground coffee sachet 140 is disposed inside the cup body 110. The ground coffee powder in the ground coffee sachet 140 is adapted to be disposed inside the filter bag 130. When using the coffee cup 100, the user pours hot water into the filter cover 120 to let the hot water pass through the ground coffee powder and the filter bag 130 to form a coffee liquid, and the infiltrated coffee liquid would flow into the cup body 110 and the coffee dreg would stay in the filter bag 130. The coffee dreg is adapted to be discarded along with the filter cover 120 and the filter bag 130 for a sanitary and convenient purpose. Also, the coffee brewed in such manner is compared to professionally brewed coffee.

In addition, the outside of the cup body 110 can be equipped with a handle 110, for the user to hold the cup body 110 without getting burned. The handle 110 can be a folded handle, to save the space required for storing the coffee cup 100.

Besides, the filter cover 120 may further comprise at least one inspection hole 122, adapted for the user to observe whether the water amount exceeds the top edge of the cup body 110 when pouring hot water, so as to avoid hot water from overflowing from the cup body 110.

Further, in the coffee cup 100 for instantly brewing ground coffee according to an embodiment of the present invention, a sugar sachet 150, a cream sachet 160 and/or a stir spoon 170 can be disposed in the cup body 110, for the user to add sugar and/or cream according to taste and stir the coffee with the stir spoon 170.

Further, the filter bag 130 can be a paper filter bag or a cloth filter bag.

When using the present invention, the filter cover 120 covers the cup body 110, and the filter bag 130 attached inside the filter cover 120 serves for the filtering function, when the ground coffee powder is disposed inside and brewed by hot water. In addition, the water amount can be observed through the inspection hole 122 to prevent the hot water from overflowing and burning the user. After the brewing is finished, the filter cover 120 along with the coffee dreg is taken out and discarded. Then, sugar and cream are added according to taste and a cup of delicious ground coffee is made.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A coffee cup for instantly brewing ground coffee, comprising:
a cup body:
a filter cover, adapted to cover the cup body;
a filter bag, disposed on the filter cover; and
a ground coffee sachet, disposed inside the cup body, wherein the ground coffee powder in the ground coffee sachet is adapted to be disposed inside the filter bag, and when hot water is poured in the filter cover and through the ground coffee powder and the filter bag, the coffee liquid flows inside the cup body and the coffee dreg remains in the filter bag, and the coffee dreg is adapted to be discarded along with the filter cover.

2. The coffee cup for instantly brewing ground coffee according to claim 1, wherein the cup body further comprises a handle.

3. The coffee cup for instantly brewing ground coffee according to claim 2, wherein the handle is a folded handle.

4. The coffee cup for instantly brewing ground coffee according to claim 1, wherein the filter cover further comprises at least one inspection hole, adapted for a user to observe whether the water amount exceeds a top edge of the cup body.

5. The coffee cup for instantly brewing ground coffee according to claim 1, further comprising a sugar sachet disposed inside the cup body.

6. The coffee cup for instantly brewing ground coffee according to claim 1, further comprising a cream sachet, disposed inside the cup body.

7. The coffee cup for instantly brewing ground coffee according to claim 1, further comprising a stir spoon, disposed inside the cup body.

8. The coffee cup for instantly brewing ground coffee according to claim 1, wherein the filter bag comprises a paper filter bag or a cloth filter bag.
